(19) United States
(12) Patent Application Publication
(10) Pub. No.: US 2026/0231184 A1
(43) Pub. Date: Aug. 6, 2026

(54) Physical Sidelink Feedback Channel Resource Determinations in Unlicensed Spectrum

(71) Applicant: Apple Inc., Cupertino, CA (US)

(72) Inventors: Chunxuan YE, San Diego, CA (US); Ankit BHAMRI, Haar (DE); Chunhai YAO, Beijing (CN); Dawei ZHANG, Saratoga, CA (US); Haitong SUN, Saratoga, CA (US); Hong HE, San Jose, CA (US); Huaning NIU, San Jose, CA (US); Sigen YE, San Diego, CA (US); Wei ZENG, Saratoga, CA (US); Zhibin WU, Los Gatos, CA (US)

(21) Appl. No.: 19/151,415

(22) PCT Filed: Feb. 2, 2023
(86) PCT No.: PCT/CN2023/074232

§ 371 Date: Jul. 28, 2025

(51) Int. Cl. H04W 72/25

(52) U.S. Cl. CPC H04W 72/25

(57) ABSTRACT

A user equipment (UE) is configured to receive configuration information for a sidelink connection in an unlicensed frequency band, the configuration information comprising a first bitmap comprising an indication of resource block (RB) sets with available Physical Sidelink Feedback Channel (PSFCH) resources and transmit PSFCH information based on the configuration information.

### TECHNICAL FIELD

This application relates generally to wireless communication systems, and in particular relates to physical sidelink feedback channel resource determinations in unlicensed spectrum.

### BACKGROUND

Several areas of User Equipment (UE) sidelink behavior in unlicensed spectrum remain undefined. Specifically, a configuration of Physical Sidelink Feedback Channel (PSFCH) resources is needed. There also exists a need to define the indexing structure of PSFCH resources. Finally, there is a need to associate PSFCH resources with Physical Sidelink Control Channel (PSCCH) and/or the Physical Sidelink Shared Channel (PSSCH) resources.

### SUMMARY

Some exemplary embodiments are related to a method performed by a user equipment (UE). The method includes receiving configuration information for a sidelink connection in an unlicensed frequency band, the configuration information comprising a first bitmap comprising an indication of resource block (RB) sets with available Physical Sidelink Feedback Channel (PSFCH) resources and transmitting PSFCH information based on the configuration information.

Other exemplary embodiments are related to a method performed by a user equipment (UE) communicating on a sidelink connection in an unlicensed frequency band. The method includes receiving a Physical Sidelink Control Channel (PSCCH) and Physical Sidelink Shared Channel (PSSCH) transmission, determining a slot and a starting interlace index that the PSCCH or PSSCH transmission was received and determining Physical Sidelink Feedback Channel (PSFCH) resources corresponding to the PSCCH and PSSCH transmission, wherein the determining is based on the slot and starting interlace index.

### BRIEF DESCRIPTION OF THE DRAWINGS

FIG. 1 shows an exemplary network arrangement according to various exemplary embodiments.

FIG. 2 shows an exemplary UE according to various exemplary embodiments.

FIG. 3 shows an exemplary base station according to various exemplary embodiments.

FIG. 4A shows a PSFCH Resource Block (RB) bitmap for RB sets according to various exemplary embodiments.

FIG. 4B shows a RB interlace bitmap for an interlace within an RB set according to various exemplary embodiments.

FIG. 4C shows a Physical Resource Block (PRB) bitmap for PRBs of an interlace according to various exemplary embodiments.

FIG. 5A shows a first indexing scheme in which a PRB index is first and an interlace index second according to various exemplary embodiments.

FIG. 5B shows a second indexing scheme in which a PRB index is first, an interlace index second, and an RB set index last, according to various exemplary embodiments.

FIG. 6 shows a third indexing scheme in which a PRB index is first, a dedicated cyclic shift pair index is second, an interlace index is third, and an RB set index is last according to various exemplary embodiments.

FIG. 7 shows a fourth indexing scheme in which a dedicated cyclic shift pair index is first, a PRB index is second, an interlace index is third, and an RB set index is last according to various exemplary embodiments.

FIG. 8A shows a first PSCCH/PSSCH indexing scheme according to various exemplary embodiments.

FIG. 8B shows a second PSCCH/PSSCH indexing scheme according to various exemplary embodiments.

FIG. 9A shows a first interlace scheme for NACK/ACK feedback according to various exemplary embodiments.

FIG. 9B shows a second interlace scheme for NACK/ACK feedback according to various exemplary embodiments.

### DETAILED DESCRIPTION

The exemplary embodiments may be further understood with reference to the following description and the related appended drawings, wherein like elements are provided with the same reference numerals. The exemplary embodiments relate to improvements to UE sidelink operations in the unlicensed spectrum.

The exemplary embodiments are described with regard to a UE. However, reference to a UE is merely provided for illustrative purposes. The exemplary embodiments may be utilized with any electronic component that may establish a connection to an accessory device and is configured with the hardware, software, and/or firmware to exchange information and data with accessory devices. Therefore, the UE as described herein is used to represent any electronic component.

The exemplary embodiments are also described with reference to a 5G New Radio (NR) network. However, it should be understood that the exemplary embodiments may also be implemented in other types of networks, including but not limited to LTE networks, future evolutions of the cellular protocol, or any other type of network.

The exemplary embodiments are also described with reference to a sidelink connection. A sidelink connection may be generally understood as transmissions between UEs (e.g., phones, tablets, smartwatches, connected vehicles, etc.) without the need for a base station to transmit or receive data. Sidelink operations may be desirable in scenarios where ultra-low latency transmissions between connected devices are needed (e.g., connected vehicles).

Several areas of User Equipment (UE) sidelink behavior in the unlicensed spectrum remain undefined. As used herein, a unlicensed spectrum may include, but is not limited to, a spectrum in which spectrum access is contention based. The exemplary embodiments relate to a configuration of Physical Sidelink Feedback Channel (PSFCH) resources, definitions of the indexing structure of PSFCH resources, and associations of PSFCH resources with Physical Sidelink Control Channel (PSCCH) and/or the Physical Sidelink Shared Channel (PSSCH) resources.

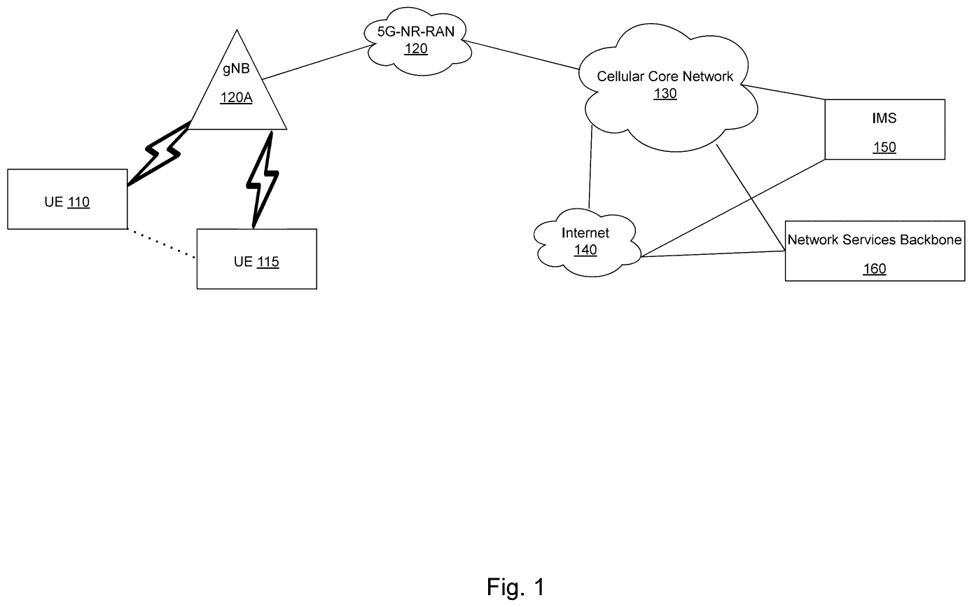

FIG. 1 shows an exemplary network arrangement 100 according to various exemplary embodiments. The exemplary network arrangement 100 includes a UE 110 and a UE 115. Those skilled in the art will understand that the UEs 110 and 115 may be any type of electronic component that is configured to communicate via a network, e.g., mobile phones, tablet computers, desktop computers, smartphones, phablets, embedded devices, wearables, Internet of Things (IoT) devices, etc. It should also be understood that an actual network arrangement may include any number of UEs being used by any number of users. Thus, the example of two UEs 110 and 115 is merely provided for illustrative purposes. Further description will relate to UE 110, but it should be understood that all description of UE 110 is applicable to UE 115 throughout this disclosure.

The UE 110 may be configured to communicate with one or more networks. In the example of the network configuration 100, the network with which the UE 110 may wirelessly communicate is a 5G NR radio access network (RAN) 120. However, it should be understood that the UE 110 may also communicate with other types of networks (e.g., 5G cloud RAN, a next generation RAN (NG-RAN), a legacy cellular network, etc.) and the UE 110 may also communicate with networks over a wired connection. With regard to the exemplary embodiments, the UE 110 may establish a connection with the 5G NR RAN 120. Therefore, the UE 110 may have a 5G NR chipset to communicate with the NR RAN 120. The UE 110 may also communicate with the UE 115 over an unlicensed sidelink connection, wherein data is exchanged between the UE 110 and the UE 115 without the gNB 120A.

The 5G NR RAN 120 may be portions of a cellular network that may be deployed by a network carrier (e.g., Verizon, AT&T, T-Mobile, etc.). The RAN 120 may include cells or base stations that are configured to send and receive traffic from UEs that are equipped with the appropriate cellular chip set. In this example, the 5G NR RAN 120 includes the gNB 120A. However, reference to a gNB is merely provided for illustrative purposes, any appropriate base station or cell may be deployed (e.g., Node Bs, eNodeBs, HeNBs, eNBs, gNBs, gNodeBs, macrocells, microcells, small cells, femtocells, etc.).

Those skilled in the art will understand that any association procedure may be performed for the UE 110 to connect to the 5G NR RAN 120. For example, as discussed above, the 5G NR RAN 120 may be associated with a particular network carrier where the UE 110 and/or the user thereof has a contract and credential information (e.g., stored on a SIM card). Upon detecting the presence of the 5G NR RAN 120, the UE 110 may transmit the corresponding credential information to associate with the 5G NR RAN 120. More specifically, the UE 110 may associate with a specific cell (e.g., gNB 120A).

The network arrangement 100 also includes a cellular core network 130, the Internet 140, an IP Multimedia Subsystem (IMS) 150, and a network services backbone 160. The cellular core network 130 manages the traffic that flows between the cellular network and the Internet 140. The IMS 150 may be generally described as an architecture for delivering multimedia services to the UE 110 using the IP protocol. The IMS 150 may communicate with the cellular core network 130 and the Internet 140 to provide the multimedia services to the UE 110. The network services backbone 160 is in communication either directly or indirectly with the Internet 140 and the cellular core network 130. The network services backbone 160 may be generally described as a set of components (e.g., servers, network storage arrangements, etc.) that implement a suite of services that may be used to extend the functionalities of the UE 110 in communication with the various networks.

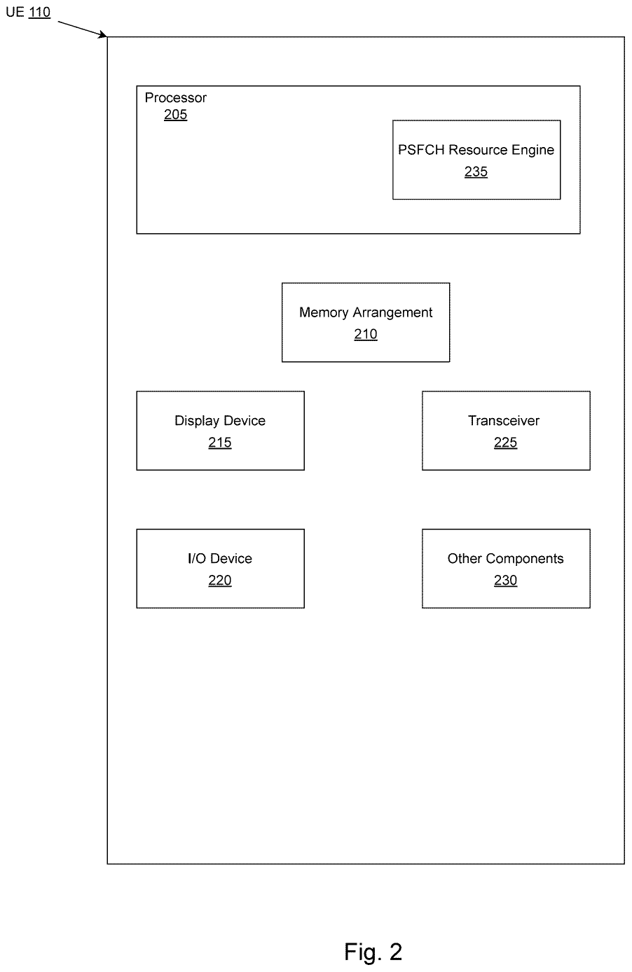

FIG. 2 shows an exemplary UE 110 according to various exemplary embodiments. The UE 110 will be described with regard to the network arrangement 100 of FIG. 1. The UE 110 may represent any electronic device and may include a processor 205, a memory arrangement 210, a display device 215, an input/output (I/O) device 220, a transceiver 225, and other components 230. The other components 230 may include, for example, an audio input device, an audio output device, a battery that provides a limited power supply, a data acquisition device, ports to electrically connect the UE 110 to other electronic devices, sensors to detect conditions of the UE 110, etc.

The processor 205 may be configured to execute a plurality of engines for the UE 110. For example, the engines may include a PSFCH Resource Engine 235 for performing operations such as generating PFSCH resource configurations, indexing PSFCH resources and associating PSHCH resources with PSCCH/PSSCH transmissions.

The above referenced engine being an application (e.g., a program) executed by the processor 205 is only exemplary. The functionality associated with the engines may also be represented as a separate incorporated component of the UE 110 or may be a modular component coupled to the UE 110, e.g., an integrated circuit with or without firmware. For example, the integrated circuit may include input circuitry to receive signals and processing circuitry to process the signals and other information. The engines may also be embodied as one application or separate applications. In addition, in some UEs, the functionality described for the processor 205 is split among two or more processors such as a baseband processor and an applications processor. The exemplary embodiments may be implemented in any of these or other configurations of a UE.

The memory arrangement 210 may be a hardware component configured to store data related to operations performed by the UE 110. The display device 215 may be a hardware component configured to show data to a user while the I/O device 220 may be a hardware component that enables the user to enter inputs. The display device 215 and the I/O device 220 may be separate components or integrated together such as a touchscreen. The transceiver 225 may be a hardware component configured to establish a connection with the 5G-NR PAN 120. Accordingly, the transceiver 225 may operate on a variety of different frequencies or channels (e.g., set of consecutive frequencies).

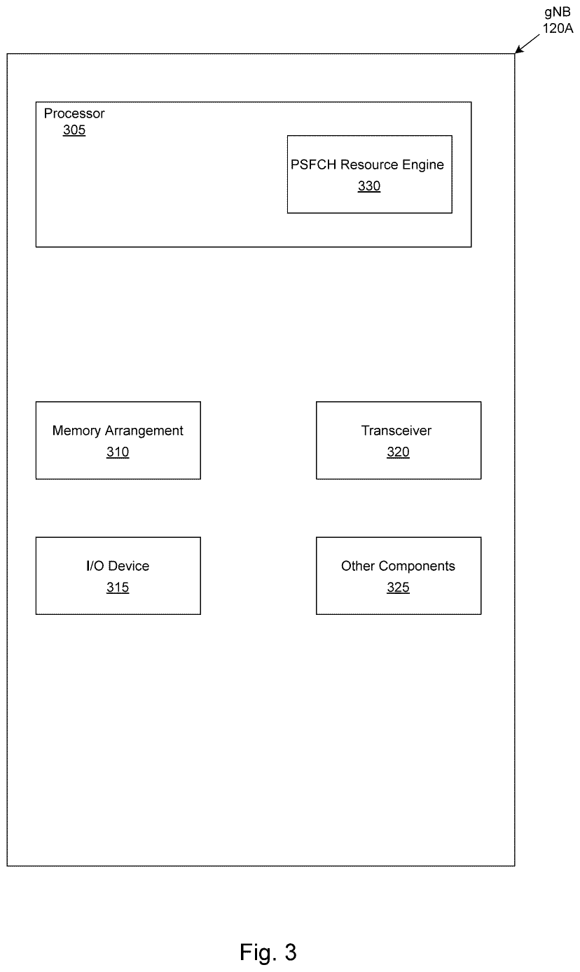

FIG. 3 shows an exemplary base station 300 according to various exemplary embodiments. The base station 300 may represent the gNB 120A or any other access node through which the UE 110 may establish a connection and manage network operations.

The base station 300 may include a processor 305, a memory arrangement 310, an input/output (I/O) device 315, a transceiver 320, and other components 325. The other components 325 may include, for example, an audio input device, an audio output device, a battery, a data acquisition device, ports to electrically connect the base station 300 to other electronic devices and/or power sources, etc.

The processor 305 may be configured to execute a plurality of engines for the UE 110. For example, the engines may include a PSFCH Resource engine 330 for performing operations such as generating PFSCH resource configurations, indexing PSFCH resources, and associating PSHCH resources with PSCCH/PSSCH transmissions.

The memory 310 may be a hardware component configured to store data related to operations performed by the base station 300. The I/O device 315 may be a hardware component or ports that enable a user to interact with the base station 300. The transceiver 320 may be a hardware component configured to exchange data with the UE 110 and any other UE in the network arrangement 100. The transceiver 320 may operate on a variety of different frequencies or channels (e.g., set of consecutive frequencies). Therefore, the transceiver 320 may include one or more components (e.g., radios) to enable the data exchange with the various networks and UEs.

One of skill in the art will recognize that a PSFCH may be generally understood as a channel that carries feedback information related to sidelink transmission success or failure. In a first aspect of the exemplary embodiments, PSFCH resource determination logic is disclosed herein.

In a first variant of the first aspect, a resource pool (pre)configuration of overall PSFCH resources may be utilized. This variant comprises several different bitmaps. In this variant, the (pre)configuration may include a first bitmap that defines a subset of Resource Block (RB) sets in a resource pool with PSFCH resources, referred to herein as a PSFCH RB set bitmap. The bitmap may have a length equal to the number of RB sets in a resource pool.

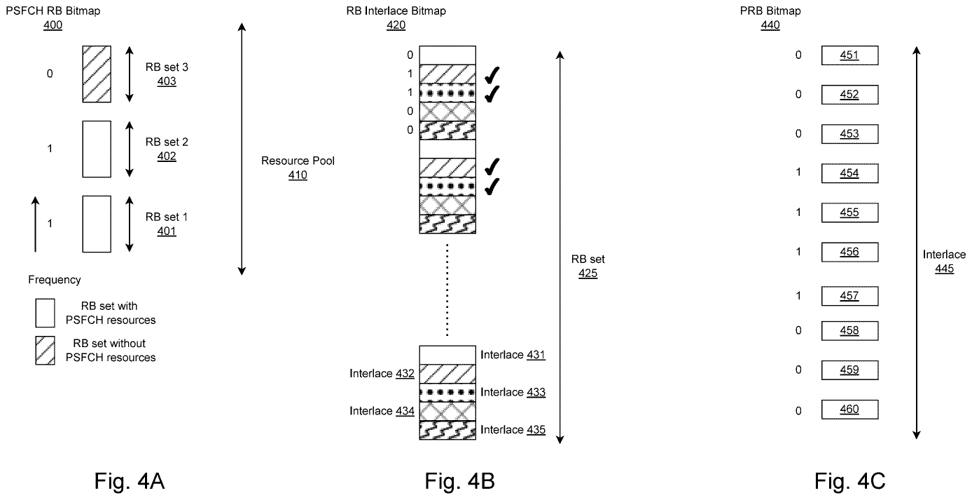

FIG. 4A shows a PSFCH RB set bitmap 400 for RB sets 401-403 according to various exemplary embodiments. In this exemplary embodiment, it may be considered that the resource pool 410 has three (3) RB sets RB sets 401-403. In the context of FIG. 4A, the y-axis of the resource pool 410 corresponds to frequency.

As described above, the (pre)configuration comprises a PSFCH RB set bitmap having a length equal to the number of RB sets in a resource pool. Thus, in this example, the PSFCH RB set bitmap 400 has a length of three corresponding to the three (3) RB sets 401-403. As shown in FIG. 4A, RB sets 401 and 402 (corresponding to the empty boxes) have PSFCH RB set bitmap values equal to 1. In this example, the PSFCH RB set bitmap values equal to 1 mean that these RB sets have PSFCH resources; in contrast, RB set 403 with a PSFCH RB set bitmap value equal to 0 does not have PSFCH resources.

In some exemplary embodiments, the (pre)configuration may comprise a second bitmap to indicate whether PSFCH resources are in a specific interlace of an RB set that has been defined as including PSFCH resources, referred to herein as an RB interlace bitmap. For example, as described above, the PSFCH RB set bitmap described with reference to FIG. 4A indicated that RB sets 401 and 402 include PSFCH resources. The RB interlace bitmap will indicate which interlaces of the RB sets 401 and 402 include the PSFCH resources. As will be described in greater detail below, the RB interlace bitmap may be a single bitmap for all the RB sets with PSFCH resources (e.g., one RB interlace bitmap corresponding to both RB sets 401 and 402), or multiple bitmaps, with each bitmap corresponding to an RB set (e.g., one RB interlace bitmap corresponding to RB set 401 and another RB interlace bitmap corresponding to RB set 402).

FIG. 4B shows a RB interlace bitmap 420 for an interlace within an RB set 425 according to various exemplary embodiments. As described above, a subset of interlaces within an RB set may be utilized for. The RB interlace bitmap 420 may have a length equal to the number of interlaces in the RB set 425 and may be used to indicate whether or not PSFCH resource are included in the interlace.

In the example of FIG. 4B, each patterned box indicates a different interlace (e.g., interlaces 431-435) of the RB set 425. Interlaces with a RB interlace bitmap value equal to 0 do not have PSFCH resources, whereas interlaces with a RB interlace bitmap equal to 1 have PSFCH resources. Thus, in this example, the interlaces 432 and 433 comprise PSFCH resources, whereas the interlaces 431, 434 and 435 do not include PSFCH resources. As described above, the RB interlace bitmap 420 may correspond to all of the RB sets that have PSFCH resources (e.g., the RB set 425 represents RB sets 401 and 402), or the RB interlace bitmap 420 may correspond to a single RB set (e.g., the RB set 425 represents RB set 401).

In some exemplary embodiments, the (pre)configuration may comprise a third bitmap to indicate whether a subset of dedicated physical resource blocks (PRBs) in an interlace have PSFCH resources, referred to herein as a PRB bitmap. For example, as described above, the RB interlace bitmap 420 described with reference to FIG. 4B indicated that interlaces 432 and 433 of the RB set 425 include PSFCH resources. The PRB bitmap will indicate which PRBs of the interlaces 432 and 433 include the PSFCH resources. As will be described in greater detail below, the PRB bitmap may be a single bitmap or multiple bitmaps. A single PRB bitmap may indicate PSFCH resources for all interlaces with PSFCH resources. A first set of multiple bitmaps may have PRB bitmaps that correspond to each interlace having PSFCH resources. A second set of multiple bitmaps may have PRB bitmaps that corresponds to each interlace per RB set having PSFCH resources.

FIG. 4C shows a Physical Resource Block (PRB) bitmap 440 for PRBs 451-460 of an interlace 445 according to various exemplary embodiments. The PRB bitmap 440 represents a subset of dedicated PRBs in the interlace 445 with informative PSFCH resources. The PRB bitmap has a length equal to the number of PRBs in an interlace, e.g., the PRB bitmap 440 has a length of ten (10) corresponding to the ten (10) PRBs 451-460 of the interlace 445. The PRB bitmap 440 may be used to indicate whether the PRB comprises informative PSFCH resources, e.g., the UE may send informative PSFCH information using the individual PRB. For example, a PRB bitmap value equal to 1 indicates the PRB may be used for informative PSFCH, whereas a PRB bitmap value equal to 0 indicates the PRB may not be used for informative PSFCH. In the example of FIG. 4C, PRBs 454-457 of interlace 445 with bitmaps equal to 1 include informative PSFCH resources, while PRBs 451-453 and 458-460 with bitmaps equal to 0 do not include informative PSFCH resources.

As described above, the PRB bitmap may be a single bitmap or multiple bitmaps. To provide an example of a single PRB bitmap, it may be considered that the RB sets 401 and 402 of FIG. 4A include PSFCH resources and each of these RB sets comprise the interlace structure as shown in FIG. 4B, e.g., each RB set includes 5 interlaces. A single PRB bitmap may provide the information as to which PRBs in each of the RB sets 401 and 402 include PSFCH resources, e.g., the same PRBs of the same interlaces.

To provide an example of the first set of multiple bitmaps where PRB bitmaps correspond to each interlace having PSFCH resources, it may again be considered that the RB sets 401 and 402 of FIG. 4A include PSFCH resources and each of these RB sets comprise the interlace structure as shown in FIG. 4B, e.g., each RB set includes 5 interlaces. Furthermore, in the example of FIG. 4B, the interlaces 432 and 433 include PSFCH resources. Thus, in this example, there are four (4) interlaces that include PSFCH resources, two (2) interlaces of RB set 401 and two (2) interlaces of RB set 402. Therefore, since each PRB bitmap corresponds to each interlace having PSFCH resources, there would be four (4) PRB bitmaps.

To provide an example of the second set of multiple bitmaps where PRB bitmaps correspond to each interlace per RB set having PSFCH resources, the example provided above for the first set of multiple bitmaps may be considered. As described above, in this example, there are four (4) interlaces that include PSFCH resources, two (2) interlaces of RB set 401 and two (2) interlaces of RB set 402. Therefore, since each PRB bitmap corresponds to each interlace per RB set having PSFCH resources, there would be two (2) PRB bitmaps, e.g., one for the interlaces of RB set 401 and one for the interlaces of RB set 402.

In a second variant of the first aspect, an association between PSFCH resources and PSSCH/PSCCH resources is disclosed herein. In the second variant, each PSFCH resource corresponding to PSSCH/PSCCH resources are determined by n and k. Each PSSCH/PSCCH resource may be understood to occur in a slot n with a starting interlace k.

PSFCH resources may be mapped to PSSCH/PSCCH resources in the time domain, with the first slot comprising PSFCH resources after the first two or three slots (via a resource pool (pre)configuration) after PSSCH/PSCCH transmissions. This may enable a receiving UE more time to process the PSFCH. In the frequency domain, PSFCH resources may be interlaced indexes in an RB set with dedicated PRB indices in the interlace (as described with respect to FIG. 4). In the code domain, PSFCH resources may be mapped to a corresponding PSSCH/PSCCH in all or part of the possible cyclic shifts in the dedicated PRBs.

PSFCH resource indexing on a PSFCH occasion may use “M” as a means of indicating the number of dedicated PRBs for a PSFCH. M may be defined as follows:

$$M = {M}_{1} ⋆ {M}_{2} ⋆ {M}_{3} ⋆ {M}_{4} ; or M = {M}_{2} ⋆ {M}_{3} ; or M = {M}_{1} ⋆ {M}_{2} ⋆ {M}_{3} .$$

M₁ is the number of RB sets with PSFCH resources.

M₂ is the number of interlaces in a RB set with PSFCH resources.

M₃ is the number of PRBs in each interlace for dedicated PSFCH resources.

M₄ is the number of dedicated cyclic shift pairs usable in each PRB dedicated for PSFCH resources. The number of cyclic shift pairs is equal the number of resource pool (pre)configured cyclic shift pairs, minus one.

As can be seen from the above equations, the exemplary embodiments always use M₂ and M₃ for calculating M (i.e., the number of dedicated PRBs for a PSFCH). Some exemplary embodiments use M₁ and M₄ to calculate M. Once M is calculated, a PSFCH index will be calculated to index each of the PRBs dedicated for PSFCH resources. The following will provide indexing rules that may be applied to generate the PSFCH index for the PRBs dedicated for PSFCH resources.

The exemplary embodiments include four alternate indexing rules. In a first alternative, a PRB index (M₃) may be first, with an interlace index (M₂) second. In a second alternative, a PRB index (M₃) may be first, an interlace index (M₂) second, and an RB set index (M₁) may be last. In a third alternative, a PRB index (M₃) may be first, a dedicated cyclic shift pair index (M₄) may be second, an interlace index (M₂) may be third, and an RB set index (M₁) may be last. In a fourth alternative, a dedicated cyclic shift pair index (M₄) may be first, a PRB index (M₃) may be second, an interlace index (M₂) may be third, and an RB set index (M₁) may be last.

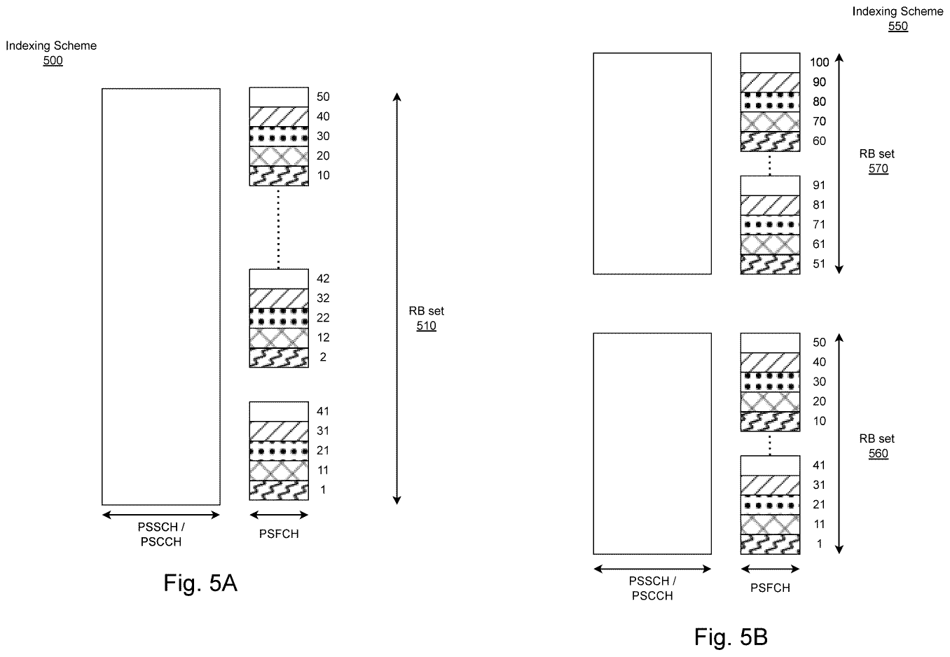

FIGS. 5A, 5B, 6, and 7 correspond to the first through fourth alternative indexing rules described above, respectively. Throughout this disclosure, it should be understood that the number of grouped interlaces and the length of the interlaces is only exemplary, and different quantities may be used by one of skill in the art. Throughout the following description of FIGS. 5A, 5B, 6, and 7, reference to number ordinality should be understood to move “up” a grouping of interlaces. For example, “first” in FIG. 5A would be 1, “second” would be 11. The ordinality relationship between PRBs continues and repeats all the way to the top of FIG. 5A, at 10.

Also, in each of the FIGS. 5A, 5B, 6, and 7, PSSCH and/or PSCCH transmissions are shown with the y-axis corresponding to frequency. Each of the FIGS. 5A, 5B, 6, and 7 also show the corresponding PSFCH transmissions for the PSSCH/PSCCH transmissions. As described above, in the time domain, the PSFCH resources may be mapped to PSSCH/PSCCH resources after the first two or three slots (via a resource pool (pre)configuration). It should be understood that the FIGS. 5A, 5B, 6, and 7 are not attempting to show this time domain correspondence as it should be understood that the PSFCH transmissions will occur in the time domain as configured.

FIG. 5A shows a first indexing scheme 500 in which a PRB index is first and an interlace index second according to various exemplary embodiments. FIG. 5A shows a single RB set 510. Each differently patterned box corresponds to a different interlace; same-patterned boxes are members of the same interlace. The indices are shown next to boxes corresponding to the interlaces.

Thus, as described above, in this example, the indexing is based on a PRB index (M₃) first and an interlace index (M₂) second. Thus, in this example, the interlaces are shown in sets of five (5) based on the example that there are five interlaces for this RB set 510. In this example, only the first two sets of PRBs in interlaces (bottom of figure) and the last set of PRBs in interlaces (top of figure) are shown. Thus, based on the indexing order described above (e.g., PRB index (M₃) first and an interlace index (M₂) second), the first set of PRBs in interlaces (bottom most interlace set) has indices of 1, 11, 21, 31, 41, the second set of PRBs in interlaces has indices of 2, 12, 22, 32, 42 and the last set of PRBs in interlaces (top most interlace set) has indices of 10, 20, 30, 40, 50.

FIG. 5B shows a second indexing scheme 550 in which a PRB index is first, an interlace index second, and an RB set index last, according to various exemplary embodiments. FIG. 5B is shown with respect to two RB sets 560 and 570. Again, each differently patterned box corresponds to a different interlace; same-patterned boxes are members of the same interlace; and the indices are shown next to boxes corresponding to the interlaces.

As described above, in this example, the indexing is based on a PRB index (M₃) first, an interlace index (M₂) second and an RB set index (M₁) last. The indexing within an RB set (e.g., RB set 560 or 570) may be similar to the indexing described above with respect to FIG. 5A because the indexing rule within the RB set (e.g., PRB index (M₃) first and an interlace index (M₂) second) is the same. However, because there is a second RB set and the indexing is based on the RB set last, there is a second set of indices for the second RB set as shown in FIG. 5B. Thus, in this example, the first set of PRBs in interlaces (bottom most interlace set) of the RB set 560 has indices of 1, 11, 21, 31, 41 and the last set of PRBs in interlaces (top most interlace set) of the RB set 560 has indices of 10, 20, 30, 40, 50, whereas the first set of PRBs in interlaces (bottom most interlace set) of the RB set 570 has indices of 51, 61, 71, 81, 91 and the last set of PRBs in interlaces (top most interlace set) of the RB set 570 has indices of 60, 70, 80, 90, 100.

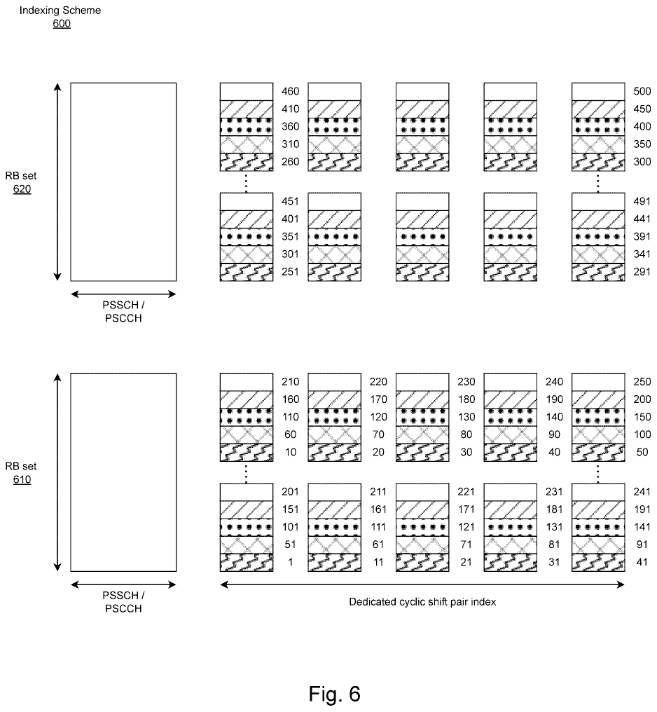

FIG. 6 shows a third indexing scheme 600 in which a PRB index is first, a dedicated cyclic shift pair index is second, an interlace index is third, and an RB set index is last according to various exemplary embodiments. FIG. 6 is shown with respect to two RB sets 610 and 620. In this figure, a move along the y-axis corresponds to a shift in frequency, whereas a move along the x-axis corresponds to a shift in the code domain (e.g., cyclic shifts). For example, 1, 11, 21, 31, and 41 are in the same time domain and same PRBs, but are in different code sequences.

As described above, the third indexing scheme 600 applies the indexing rules in the order a PRB index (M₃), a dedicated cyclic shift pair index (M₄), an interlace index (M₂) and an RB set index (M₁). Of note here is that each column in an RB set is a different cyclic shift pair and in the example of FIG. 6, there are five cyclic shift pairs. Moving up a column between same-patterned boxes should be understood to represent a next PRB in the same interlace, in the same RB set, in the same cyclic shift. While not shown in FIG. 6, this may be represented by moving from PRB 1 to 2, 3, 4 . . . 10. This behavior may be repeated in a plurality of cyclic shift pairs. For example, 11-20 would follow the same pattern structure as 1-10, but in a different cyclic shift pair.

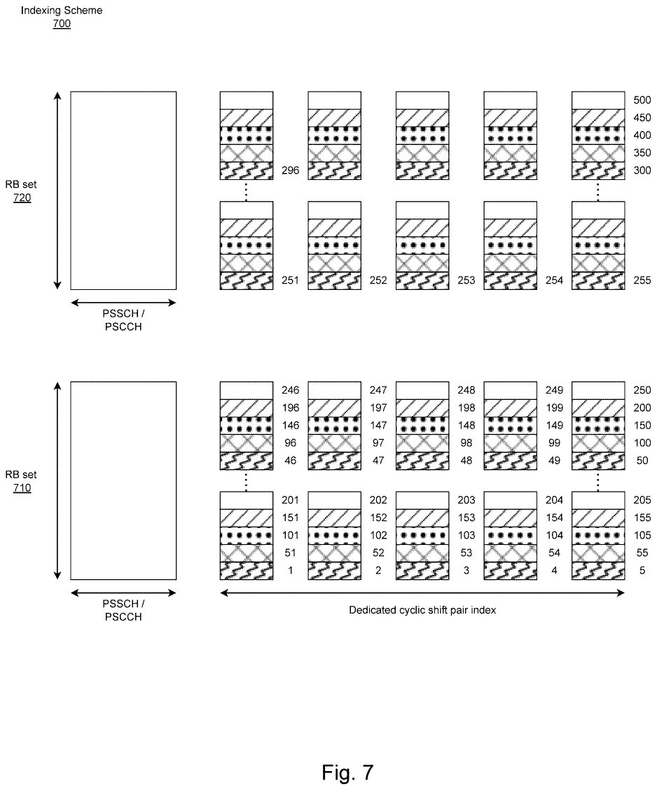

FIG. 7 shows a fourth indexing scheme 700 in which a dedicated cyclic shift pair index is first, a PRB index is second, an interlace index is third, and an RB set index is last, according to various exemplary embodiments. FIG. 7 is shown with respect to two RB sets 710 and 720 and is substantially similar to FIG. 6, but instead has swapped the dedicated cyclic shift pair index with the PRB index to be first.

The exemplary embodiments may also include indexing the PSSCH/PSCCH resources to be applied against the corresponding PSFCH index. The PSSCH/PSCCH resource indexing may be based on using a calculated value “N” that may be defined as the number of PSSCH/PSCCH sub-channels per PSFCH periodicity. N may be equal to N₁*N₂, where N₁ is the PSFCH periodicity (e.g., 1, 2, or 4 slots) and N₂ equals the number of PSSCH/PSCCH sub-channels in a slot, which are counted over all RB sets in a resource pool or over each RB set. N₂ incorporates multiple RB sets of a resource pool. N₃ may be defined as the number of PSFCH retransmissions. If multiple PSFCH transmissions are allowed, PSFCH resources may be used to support additional PSSCH/PSCCH transmissions. N may be alternatively defined as N₁*N₂*N₃.

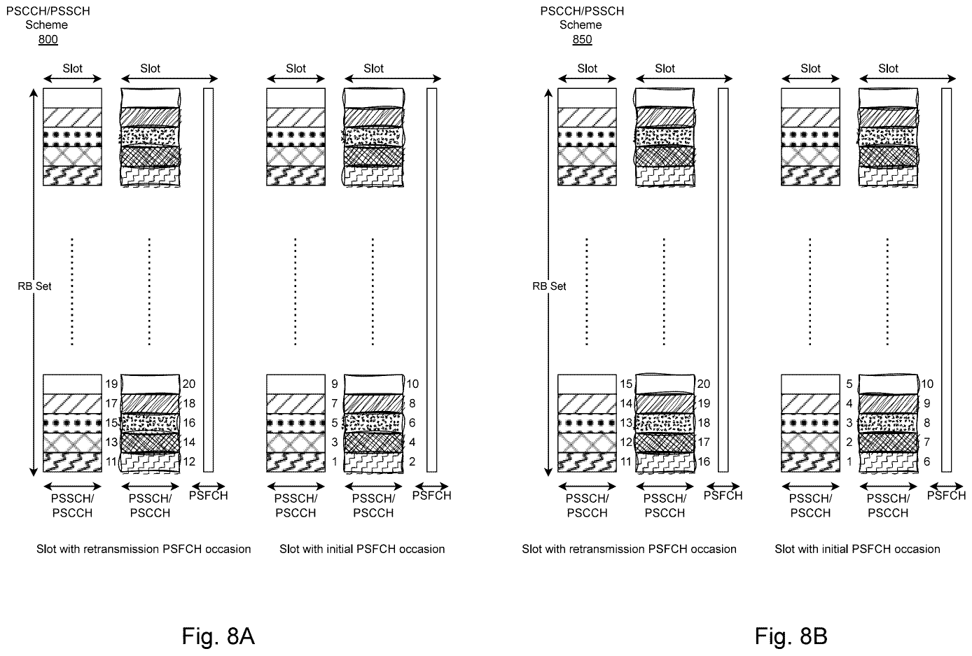

The exemplary embodiments may apply two alternative rule sets for PSSCH/PSCCH resource indexing. In a first rule set, a slot index (N₂) comes first, a subchannel index (N₁) comes second, and a PSFCH transmission occasion index (N₃) comes last. In a second rule set, a subchannel index (N₁) comes first, a slot index (N₂) comes second, and a PSFCH transmission occasion index may come last. FIG. 8A and FIG. 8B correspond to the first and second rule sets, respectively.

FIG. 8A shows a first PSCCH/PSSCH indexing scheme 800, according to various exemplary embodiments. Of note in FIG. 8 is a PFSCH resource every two slots. The right two slots are the initial transmission, whereas the left two slots are a retransmission. In FIG. 8A, a slot index (N₂) comes first, a subchannel index (N₁) comes second, and a PSFCH transmission occasion index (N₃) comes last. Thus, in this example, the indexing alternates between slots because the slot index is first.

FIG. 8B shows a second PSCCH/PSSCH indexing scheme 850, according to various exemplary embodiments. In this scheme, a subchannel index (N₁) comes first, a slot index (N₂) comes second, and a PSFCH transmission occasion index (N₃) may come last. Thus, in this example, the indexing continues for the same slot because the subchannel index is first.

Thus, at this point, the dedicated PRBs for PSFCH are indexed and the PSCCH/PSSCH transmissions are indexed. It may now be considered that each PSSCH/PSCCH transmission has L corresponding PSFCH resources, where L=M/N, where M is the total number of PSFCH resources and N is the total number of PSSCH/PSCCH resources. In the case that M/N is not an integer, a flooring operation may be used to arrive at an integer value of L.

As mentioned above, M₄ may be defined as the number of dedicated cyclic shift pairs usable in each PRB dedicated for PSFCH resources and the number of cyclic shift pairs is equal the number of resource pool (pre)configured cyclic shift pairs, minus one. As described above, in some exemplary embodiments, M₄ is used to calculate M. If M₄ is used to calculate M, then L should be an integer multiple of M₄. In this case, all the dedicated cyclic shift pairs associated with a dedicated PRB are allocated to a single PSSCH/PSCCH transmission.

In other exemplary embodiments, M₄ is not used to calculate M, then L may be updated by L*M4. For a given PSSCH/PSSCH resource index X, the starting PSFCH resource index Y may be defined as the smallest integer larger than (X−1)*L+1, such that all the L subsequent PSFCH resources occur in the same interlace of a single RB set.

Each receiving UE may use one of L PSFCH resources, based on its physical layer source ID and group member ID. A PRB with a dedicated cyclic shift is not used to for a common cyclic shift. In a first alternative, a common cyclic shift is based on a single cyclic shift for all PRBs in the interlace. In a second alternative, a common cyclic shift is based on a cyclic shift cycling over different PRBs in the interlace.

Several alternatives exist for which member cyclic shift pairs may be used for PSFCH resources. In a first alternative, it may be defined to use the smaller cyclic shift in the pair. In a second alternative, it may be (pre)configured per-resource pool as to which one of the pair is to be used. In a third alternative, selecting the member of the common cyclic shift pair may be indicated by sidelink control information (SCI) of the PSCCH that triggers the PSFCH. In a fourth alternative, the selected member of the common cyclic shift pair may be determined by the source ID of a PSSCH/PSCCH transmission.

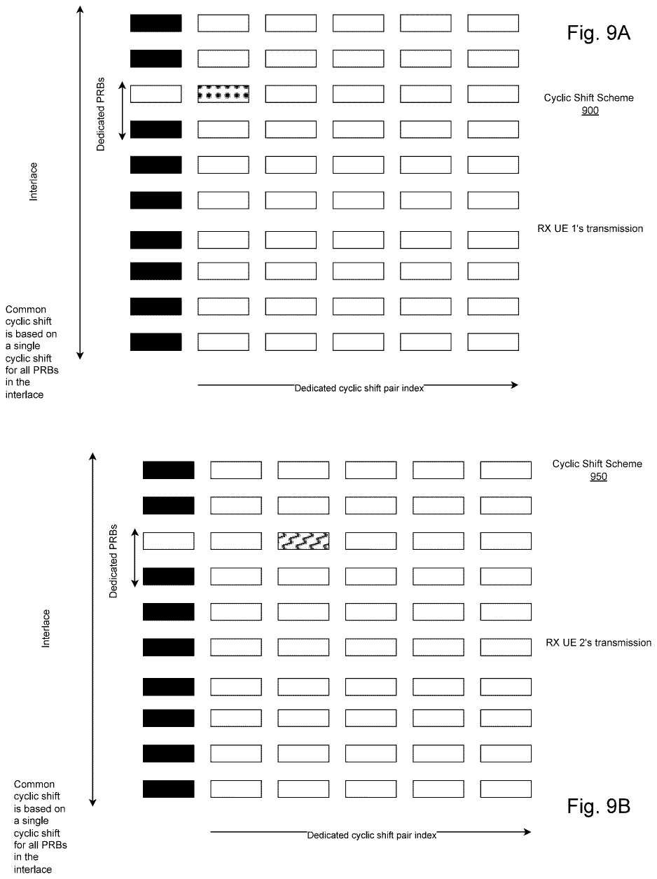

FIG. 9A shows a first cyclic shift scheme 900 for NACK/ACK feedback according to various exemplary embodiments. The y-axis of FIG. 9A are PRBs of an interlace, whereas the x-axis is the code domain, with each column representing a different cyclic shift pair. The common cyclic shift is based on a single cyclic shift for all PRBs in the interlace. In FIG. 9A, a single PRB in the common cyclic shift, as well as an additional PRB in the dedicated cyclic shift pair index may be used for ACK/NACK feedback.

FIG. 9B shows a second cyclic shift scheme 950 for NACK/ACK feedback according to various exemplary embodiments. Of note in FIG. 9B compared to FIG. 9A is the use of a different cyclic shift pair for use in transmission of NACK/ACK feedback. FIG. 9A and FIG. 9B represent two separate receiving UEs, with both UEs receiving a same transmission. FIGS. 9A and 9B demonstrate that different PRBs and different cyclic shifts may be used to indicate a NACK/ACK.

### Examples

In a first example, a method is performed by a user equipment (UE) communicating on a sidelink connection in an unlicensed frequency band, comprising receiving a Physical Sidelink Control Channel (PSCCH) and Physical Sidelink Shared Channel (PSSCH) transmission, determining a slot and a starting interlace index that the PSCCH or PSSCH transmission was received and determining Physical Sidelink Feedback Channel (PSFCH) resources corresponding to the PSCCH and PSSCH transmission, wherein the determining is based on the slot and starting interlace index.

In a second example, the method of the first example, wherein determining the PSFCH resources comprises determining a PSFCH index.

In a third example, the method of the second example, further comprising determining a resource index for the PSCCH or PSSCH transmission.

In a fourth example, the method of the third example, wherein the determining PSFCH resources corresponding to the PSCCH or PSSCH transmission comprises determining a number of dedicated PRBs for PSFCH, determining a number of PSSCH or PSCCH sub-channels per PSFCH periodicity, wherein each PSSCH or PSCCH transmission has corresponding PSFCH resources based on a number determined by dividing the number of dedicated PRBs for PSFCH by the number of PSSCH or PSCCH sub-channels per PSFCH periodicity.

In a fifth example, the method of the fourth example, wherein, when the number determined by dividing the number of dedicated PRBs for PSFCH by the number of PSSCH or PSCCH sub-channels per PSFCH periodicity does not result in an integer, performing a flooring operation.

In a sixth example, the method of the fourth example, wherein the determining PSFCH resources corresponding to the PSCCH or PSSCH transmission comprises determining a number of dedicated cyclic shift pairs usable in each PRB dedicated for PSFCH resources is used to determine the number of dedicated PRBs for PSFCH, wherein all the dedicated cyclic shift pairs associated with a dedicated PRB are allocated to a single PSSCH or PSCCH transmission.

In a seventh example, the method of the fourth example, wherein the determining PSFCH resources corresponding to the PSCCH or PSSCH transmission comprises determining a number of dedicated cyclic shift pairs usable in each PRB dedicated for PSFCH resources is not used to determine the number of dedicated PRBs for PSFCH, updating the number determined by dividing the number of dedicated PRBs for PSFCH by the number of PSSCH or PSCCH sub-channels per PSFCH periodicity by multiplying the number by the number of dedicated cyclic shift pairs usable in each PRB dedicated for PSFCH resources, wherein for the resource index having a first value, a starting PSFCH index value is a smallest integer larger than a number determined by multiplying the (first value −1) and (the updated number determined by dividing the number of dedicated PRBs for PSFCH by the number of PSSCH or PSCCH sub-channels per PSFCH periodicity +1), wherein all the updated number determined by dividing the number of dedicated PRBs for PSFCH by the number of PSSCH or PSCCH sub-channels per PSFCH periodicity subsequent PSFCH resources are in a same interlace of a single RB set.

In an eighth example, the method of the fourth example, wherein the UE uses one of the available PSFCH resources based on a UE physical layer source identification (ID) or a group member ID.

In a ninth example, the method of the fourth example, further comprising transmitting an ACK or NACK message in a common cyclic shift PRB.

In a tenth example, the method of the ninth example, wherein the common cyclic shift PRB is based on a single cyclic shift for all PRBs in at least one of a plurality of interlaces.

In an eleventh example, the method of the ninth example, wherein the common cyclic shift PRB is based on cyclic shift cycling over one or more PRBs in an interlace.

In a twelfth example, the method of the fourth example, further comprising transmitting an ACK or NACK message in one of a common cyclic shift pair PRB, wherein selecting a member of a cyclic shift pair comprises one of (i) selecting the smaller cyclic shift of the cyclic shift pair (ii), receiving preconfiguration per resource pool (iii), receiving an indication via a sidelink control information (SCI) message or (iv), receiving an indication by a source ID in the PSSCH or PSCCH transmission.

Those skilled in the art will understand that the above-described exemplary embodiments may be implemented in any suitable software or hardware configuration or combination thereof. An exemplary hardware platform for implementing the exemplary embodiments may include, for example, an Intel x86 based platform with compatible operating system, a Windows OS, a Mac platform and MAC OS, a mobile device having an operating system such as iOS, Android, etc. The exemplary embodiments of the above described method may be embodied as a program containing lines of code stored on a non-transitory computer readable storage medium that, when compiled, may be executed on a processor or microprocessor.

Although this application described various embodiments each having different features in various combinations, those skilled in the art will understand that any of the features of one embodiment may be combined with the features of the other embodiments in any manner not specifically disclaimed or which is not functionally or logically inconsistent with the operation of the device or the stated functions of the disclosed embodiments.

It is well understood that the use of personally identifiable information should follow privacy policies and practices that are generally recognized as meeting or exceeding industry or governmental requirements for maintaining the privacy of users. In particular, personally identifiable information data should be managed and handled so as to minimize risks of unintentional or unauthorized access or use, and the nature of authorized use should be clearly indicated to users.

It will be apparent to those skilled in the art that various modifications may be made in the present disclosure, without departing from the spirit or the scope of the disclosure. Thus, it is intended that the present disclosure cover modifications and variations of this disclosure provided they come within the scope of the appended claims and their equivalent.

What is claimed:

1. A method performed by a user equipment (UE), comprising:
receiving configuration information for a sidelink connection in an unlicensed frequency band, the configuration information comprising a first bitmap comprising an indication of resource block (RB) sets with available Physical Sidelink Feedback Channel (PSFCH) resources; and
transmitting PSFCH information based on the configuration information.

2. The method of claim 1, wherein the first bitmap has a length equal to a number of RB sets in a resource pool.

3. The method of claim 1, wherein the configuration information further comprises a second bitmap comprising an indication of interlaces with available PSFCH resources within RB sets having PSFCH resources.

4. The method of claim 3, wherein the second bitmap comprises a single bitmap for all RB sets having PSFCH resources.

5. The method of claim 3, wherein the second bitmap comprises multiple bitmaps each corresponding to an RB set having PSFCH resources.

6. The method of claim 3, wherein the configuration information further comprises a third bitmap comprising an indication of Physical Resource Blocks (PRBs) with dedicated or informative PSFCH resources within interlaces having PSFCH resources.

7. The method of claim 6, wherein the third bitmap comprises a single bitmap for all interlaces having PSFCH resources.

8. The method of claim 6, wherein the third bitmap comprises multiple bitmaps each corresponding to an interlace having PSFCH resources.

9. The method of claim 6, wherein the third bitmap comprises multiple bitmaps each corresponding to an interlace of an RB set having PSFCH resources.

10. A method performed by a user equipment (UE) communicating on a sidelink connection in an unlicensed frequency band, comprising:
receiving a Physical Sidelink Control Channel (PSCCH) and Physical Sidelink Shared Channel (PSSCH) transmission;
determining a slot and a starting interlace index that the PSCCH or PSSCH transmission was received; and
determining Physical Sidelink Feedback Channel (PSFCH) resources corresponding to the PSCCH and PSSCH transmission, wherein the determining is based on the slot and starting interlace index.

11. The method of claim 10, wherein determining the PSFCH resources comprises determining a PSFCH index.

12. The method of claim 11, wherein determining the PSFCH index comprises:
determining a number of interlaces in an RB set with PSFCH resources;
determining a number of physical resource block (PRBs) in each of the interlaces having a dedicated PSFCH resource;
determining a number of dedicated PRBs for PSFCH based on at least the number of interlaces in the RB set and the number of PRBs in each of the interlaces; and
generating the PSFCH index for the number of dedicated PRBs for PSFCH based on at least the number of interlaces in the RB set and the number of PRBs, wherein the number of dedicated PRBs is applied before the number of interlaces when determining the PSFCH index.

13. The method of claim 12, wherein determining the PSFCH index further comprises:
determining a number of interlaces in an RB set with PSFCH resources, wherein determining the number of dedicated PRBs for PSFCH is further based on the number of interlaces in an RB set with PSFCH resources,
wherein generating the PSFCH index for the number of dedicated PRBs is further based on the number of RB sets with PSFCH resources,
wherein the number of interlaces is applied before the number of RB sets with PSFCH resources when determining the PSFCH index.

14. The method of claim 13, wherein determining the PSFCH index further comprises:
determining a number of dedicated cyclic shift pairs usable in each PRB dedicated for PSFCH resources, wherein determining the number of dedicated PRBs for PSFCH is further based on the number of dedicated cyclic shift pairs usable in each PRB dedicated for PSFCH resources,
wherein generating the PSFCH index for the number of dedicated PRBs is further based on the number of dedicated cyclic shift pairs usable in each PRB dedicated for PSFCH resources,
wherein the number of dedicated cyclic shift pairs usable in each PRB dedicated for PSFCH resources is applied before the number of interlaces when determining the PSFCH index.

15. The method of claim 13, wherein determining the PSFCH index further comprises:
determining a number of dedicated cyclic shift pairs usable in each PRB dedicated for PSFCH resources, wherein determining the number of dedicated PRBs for PSFCH is further based on the number of dedicated cyclic shift pairs usable in each PRB dedicated for PSFCH resources,
wherein generating the PSFCH index for the number of dedicated PRBs is further based on the number of dedicated cyclic shift pairs usable in each PRB dedicated for PSFCH resources,
wherein the number of dedicated cyclic shift pairs usable in each PRB dedicated for PSFCH resources is applied before the number of dedicated PRBs when determining the PSFCH index.

16. The method of claim 11, further comprising:
determining a resource index for the PSCCH or PSSCH transmission.

17. The method of claim 16, wherein determining the resource index comprises:
determining a PSFCH periodicity;
determining a number of subchannels in a slot for the PSCCH or PSSCH, wherein the number of subchannels in the slot is counted over all RB sets in a resource pool or over each RB set; and
determining a number of PSSCH or PSCCH sub-channels per PSFCH periodicity based on the PSFCH periodicity and the number of subchannels in the slot.

18. The method of claim 17, wherein determining the resource index further comprises:
determining a number of PSFCH retransmissions, wherein the number of PSSCH or PSCCH sub-channels per PSFCH periodicity is further based on the number of PSFCH retransmissions.

19. The method of claim 18, wherein the number of subchannels in a slot for the PSCCH or PSSCH is applied before the PSFCH periodicity and the PSFCH periodicity is applied before the number of PSFCH retransmissions when determining the resource index.

20. The method of claim 18, wherein the PSFCH periodicity is applied before the number of subchannels in a slot for the PSCCH or PSSCH and the number of subchannels in a slot for the PSCCH or PSSCH is applied before the number of PSFCH retransmissions when determining the resource index.
